(19) United States
(12) Patent Application Publication
(10) Pub. No.: US 2015/0019769 A1
(43) Pub. Date: Jan. 15, 2015

(54) DATA EXCHANGE AND STORAGE DEVICE

(71) Applicant: SAGEMCOM DOCUMENTS SAS, Rueil Malmaison (FR)

(72) Inventor: Michel Bapseres, Rueil Malmaison (FR)

(21) Appl. No.: 14/367,224

(22) PCT Filed: Oct. 18, 2012
(86) PCT No.: PCT/EP2012/070686

§ 371 Date: Jun. 19, 2014

(30) Foreign Application Priority Data
Dec. 22, 2011 (FR) 1162323

(51) Int. Cl. G06F 13/38

(52) U.S. Cl. CPC G06F 13/385
USPC 710/63

(57) ABSTRACT

The invention concerns a device (1) comprising a portion of cable (3) with a male USB connector (3a) connected to a module (2) capable of operating as a USB peripheral device, said device being characterised in that the device also comprises a portion of cable with a female USB connector (3b) connected to the module, said module being capable of operating also as a USB host, the male and female connectors being capable of being connected to one another in such a way that the portions of cable form a loop together with the module, the module being configured to control the data exchanges depending on the connection status of the male USB connector and female USB connector thereof.

### GENERAL TECHNICAL FIELD

The invention relates to a removable USB device.

### STATE OF THE ART

Removable USB peripherals, notably USB sticks, are conventionally known.

They integrate electronics allowing them to manage the storage and exchange of data and are usually provided with male connectors, which allow them to be connected to host devices, such as micro-computers, themselves provided with female connectors.

Moreover connecting cables are already known, one end of which is with a male connector and the other end of which is with a female connector and both ends of which may be connected to each other in order to form a loop, for allowing a user to wear a device as a necklace or bracelet. A connection of this type is for example proposed in application EP 2 241 935.

### PRESENTATION OF THE INVENTION

An object of the invention is to propose a removable device which may be used both as a USB peripheral and as a USB host.

For this purpose, it proposes a device including a cable portion with a male USB connector connected to a module being able to operate as a USB peripheral, characterized in that it also includes a cable portion with a female USB connector connected to a module, said module being able to operate also as a USB host, the male and female connectors being able to be connected to each other so that the cable portions form, together with the module, a loop, the module being configured for controlling the exchange of data depending on the connection state of its male USB connector and of its female USB connector.

The different embodiments of the invention provide many advantages.

Thus, the device for storing and exchanging data is compact and easy to convey.

Further, the latter adapts immediately, without requiring any additional cables to any electronic device having a USB connector.

In particular, the proposed device has optimum handling of the connections made by the connectors of the device and avoids any malfunction. In particular, it avoids the discharging of the battery of the module into the electronics of the latter when both cable connections are connected to each other.

Finally, connectors and readers may be incorporated to the device while avoiding the presence of bulky and unsightly external connections.

### PRESENTATION OF THE FIGURES

Other features, objects and advantages of the invention will become apparent from the description which follows, which is purely illustrative and non-limiting and which should be read with reference to the appended drawings wherein:

FIG. 1 is a schematic illustration of an embodiment of the device according to the invention;

FIG. 2 is a schematic illustration of an embodiment of the control for charging the battery of the device and data exchanges;

FIGS. 3 and 4 are an illustration of an embodiment of a cable portion of a device according to the invention;

FIG. 5 is an illustration of an embodiment of a device according to the invention.

### DETAILED DESCRIPTION

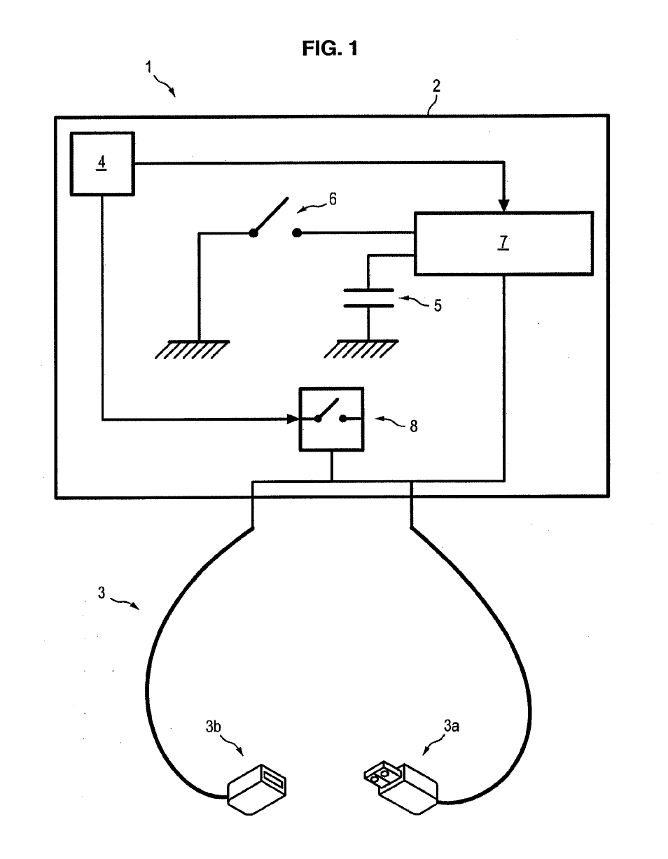

In FIG. 1 is schematically illustrated an embodiment of a device 1 which is able to operate both as a USB peripheral or as a host.

The device 1 comprises a module 2 with the memory medium and a USB cable 3, a portion 3a of which ends with a male USB connector and a portion 3b of which ends with a female USB connector.

By male USB connector is meant here and in all the present text, the fact that the connector has a protruding endpiece, able to cooperate with a slot of a female USB connector. Also, the female connector comprises a slot, adapted so as to cooperate with a male endpiece of a male USB connector.

The module 2 in particular includes a micro-processor 4 which handles the exchanges, a battery 5 able to be recharged, a switch 6, a unit 8 for controlling data exchanges to the module 2 and from the module 2, and if necessary, a unit 7 for handling the charging of the battery 5. The units 7 and 8 are electronic units.

The whole of the electronics of module 2 is for example, positioned in a plastic protective shell. Various electronic, optical or mechanical additional elements are present in the device 1 depending on the nature of the device 1. For example, if the device 1 is a camera, the latter comprises in a known way an objective and an array of sensors, the processor 4 allowing the handling of the image shooting.

The male USB connector 3a may be connected with the female USB connector of an electronic device, for example a USB port of a micro-computer or else a USB port of a loading adaptor, for exchanging data and/or exchanging energy for charging purposes.

The female USB connector 3b may be connected with the male USB connector of an electronic device, for exchanging data.

Further, the male USB connector 3a and the female USB connector 3b are able to be connected together, the cable portions thereby forming with the module 2 a closed link. This allows easy and ergonomic conveyance of the device 1 by a user, via grasping by hand the thereby made closed lace, which may also be used as a bracelet or necklace for allowing the user to easily carry said device 1.

Depending on whether the connectors 3a, 3b are engaged or not into other USB connectors and, when they are connected, depending on whether they are connected to an electronic device (micro-computer, for example) as a peripheral or as a host, to a charging adapter or further whether they are connected together, the units 7 and 8 of the module 2 detect for them a given connection condition.

The unit 8 of the module 2 is configured (“hardware”) for controlling data exchange. If necessary, the unit 7 is configured for controlling the charging of the battery 5 depending on the connection state of the male USB connector 3a and of the female USB connector 3b.

### Charging of the Battery

In an embodiment, the unit 7 handles the charging of the battery 5 depending on the connection state of the male USB connector 3a and of the female USB connector 3b.

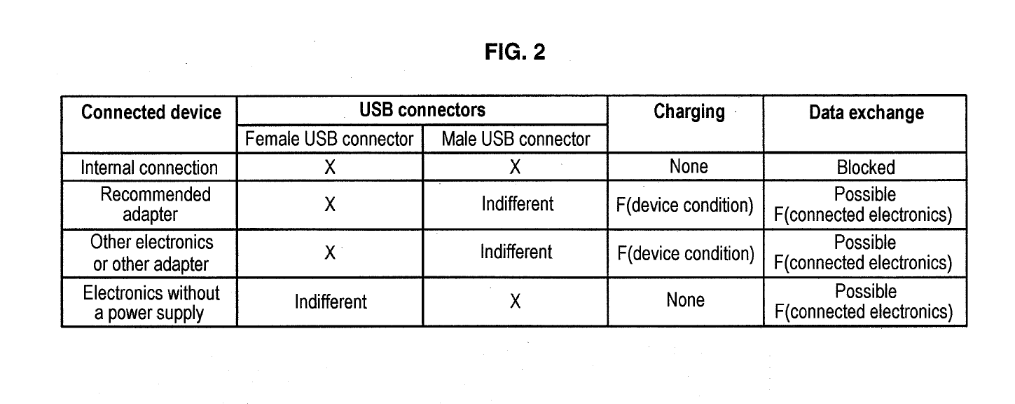

Thus, and as illustrated by the table of FIG. 2, the unit 7 is configured in order to prevent charging of the battery 5 when the connection condition of the connectors corresponds to a connection between the male USB connector 3a and the female USB connector 3b.

Indeed, in this case, the male USB connector 3a is actually connected. Now, in this connection configuration, it is of course not desirable that the battery 5 discharges into the electronics of the model 2.

Also, the electronic unit 7 for handling the charging is, when the male USB connector 3a is connected to electronics itself integrating a source of energy, configured for handling the intensity of the charging of the battery 5 depending on the nature of the source.

Thus, the unit 7 allows a charging intensity level or another one depending on whether the male USB connector 3a is connected to a source of energy, such as for example a charging adaptor or electronics having its own source of energy, as a peripheral for the latter.

Also, the electronic unit 7 for handling the charging of the battery, when the male USB connector 3a is connected to electronics having its own power supply (battery, or connection to the mains), is configured for imposing different charging conditions depending on the conditions of the switch 6.

Thus, for example, when these electronics are a charging adapter recommended by the manufacturer, the unit 7 imposes a charging intensity at a low level when the switch 6 is in an “ON” position, the device 1 being in an active condition. It imposes charging with a high intensity level when the device 1 is in an inactive condition, the switch 6 being in the “OFF” position. Here these are relative intensity levels.

As this is understood, it is desirable to impose a higher charging level when the device 1 is inactive, in order to benefit from this condition for recharging the device 1.

When the male USB connector is connected to another charging adapter (for example an adapter not recommended by the manufacturer) or to other electronics, the module is configured for preventing charging of the battery 5 through the adapter or the energy source of the other electronics, if the device is in an inactive condition, and for imposing a low-level charging intensity if the device is in an active condition. This other electronics is for example electronics of the micro-computer type.

The connection state of the female connector 3b is indifferent to the charging of the battery 5 via the male connector 3a: the female connector 3b, as for it, may not be connected or connected to another storage device, for example of the USB stick type.

Also, when the female USB connector 3b is connected to an electronic device capable of storing data and not comprising any power supply, the unit 7 for handling charging handles the absence of charging from this electronic device. For example, the question is to handle the fact that the battery 5 of the device 1 does not have to be charged in this case. The relevant device is for example a USB stick.

### Data Exchange

In an embodiment, the unit 8 is configured for controlling the data exchange depending on the connection state of the male USB connector 3a and of the female USB connector 3b, or of other connectors or readers of the device.

The unit 8 is configured so as to prevent any transfer of data through the male and female USB connectors 3a, 3b in the case of a connection of the male USB connector 3a, with the female USB connector 3b (cf. FIG. 2). Indeed, the connection of both connectors normally tends to trigger a data exchange process. However, the unit 8 receives at the output of the processor 4 a signal which stops this exchange.

In the case when the male USB connector 3a and/or the female USB connector 3b are connected to electronics, the unit 8 is configured for handling the exchange of data depending on the nature of these electronics. As mentioned earlier, the device 1 is both adapted for operating as a USB peripheral (e.g.: an operation of the USB stick type) or as a host peripheral (e.g.: operation of the micro-computer type receiving a USB stick).

If the male USB connector 3a is connected to electronics which are not adapted for exchange of data, such as for example an adapter, or is not connected, the unit 8 is configured for handling the absence of data exchange via the male USB connector 3a.

In this case, if the female USB connector 3b is simultaneously connected to a USB peripheral capable of exchanging data, the unit 8 allows and handles the exchanges of data via the female USB connector 3b while handling the absence of data exchange via the male USB connector 3a. However, if the female USB connector 3b is not connected or is connected to electronics not able to exchange data, the unit 8 handles the absence of data exchange via both male and female connectors 3a, 3b.

In the case when the male USB connector 3a is connected to electronics adapted for data exchange, such as a micro-computer, the unit 8 is configured for allowing exchange of data between the device 1 and these electronics via the male USB connector 3a. In this case, if the female connector 3b is simultaneously connected to electronics not able to exchange data or not connected, the unit 8 is configured for handling the absence of data exchange via the female USB connector 3b.

In the case when the male USB connector 3a and the female USB connector 3b are each connected to electronics adapted for data exchange, the unit 8 handles the simultaneous exchange of data through the male USB connector 3a and the female USB connector 3b. As a non-limiting example, the device 1 is connected both to a micro-computer via the male USB connector 3a and receives as a host peripheral a USB stick via the female USB connector 3b.

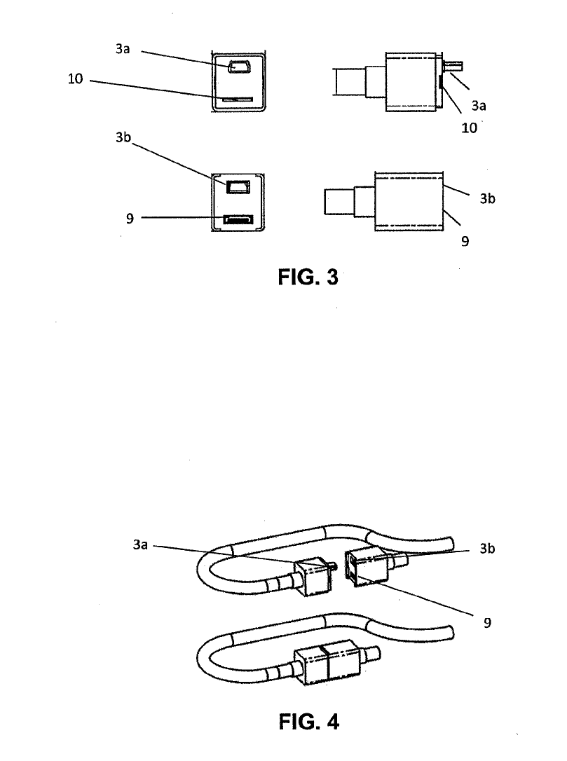

In an embodiment, illustrated in FIGS. 3 and 4, the cable portion 3 with a male USB connector 3a, and/or the cable portion 3 with a female USB connector 3b further comprise at least one additional connector 9 for exchanging data. This connector 9 is for example positioned on the same face of the cable portion 3 as the male USB connector and/or as the female USB connector.

For example, this additional connector 9 is a HDMI (“High Definition Multimedia Interface”) connector. This HDMI connector is generally a female connector allowing exchange of visual data (images, video), and/or audio data, with compatible electronics (television sets, etc.).

In the case when the male USB connector 3a and the additional connector 9 are each connected to electronics adapted for data exchange, the unit 8 handles the simultaneous exchange of data through the USB connector and the additional connector 9. For example, the unit 8 allows transfer of data towards the device 1 through the male USB connector 3a and the additional connector 9, or allows reception of data through a connector and sending of data via the other connector.

The same applies if both the male USB connector 3 the female USB connector 3b, and the additional connector 9 are each connected to electronics adapted for data exchange.

In an embodiment (c.f. FIG. 3) the cable portion 3 with a male USB connector 3a, and/or the cable portion 3 with a female USB connector 3b further comprise at least one memory card reader 10. This reader 10 is for example positioned on the same face of the cable portion as the male USB connector and/or as the female USB connector.

This reader 10 is able to receive and to read a removable memory card, for reading data stored in the card.

This is for example, an SD (Secure Digital) card reader. This type of card is used for storing data in digital cameras, digital video cameras and other apparatus of this type. These may be other cards according to the storage standards used.

The unit 8 handles the simultaneous exchange of data in the case where the reader 10 receives a card, and whether one or more of the other connectors 3a, 3b and/or 9 are also connected to electronics for data exchange.

In the case when the charging of the battery 5 is handled according to the connection condition of the male USB connector 3a or female USB connector 3b, in addition to the exchange of data through one of the connectors and/or through the reader 10, the units 7 and the unit 8 operate in parallel according to embodiments described earlier for each of these units. For example, the unit 7 handles the charging of the battery 5 via one of the USB connectors and the unit 8 handles the data transfer via one of the connectors or via the reader 10.

As this is seen, a plurality of connectors and/or readers may be positioned in the cable portion, which gives the possibility of avoiding external connections and in previously ergonomics and the aspect of the device.

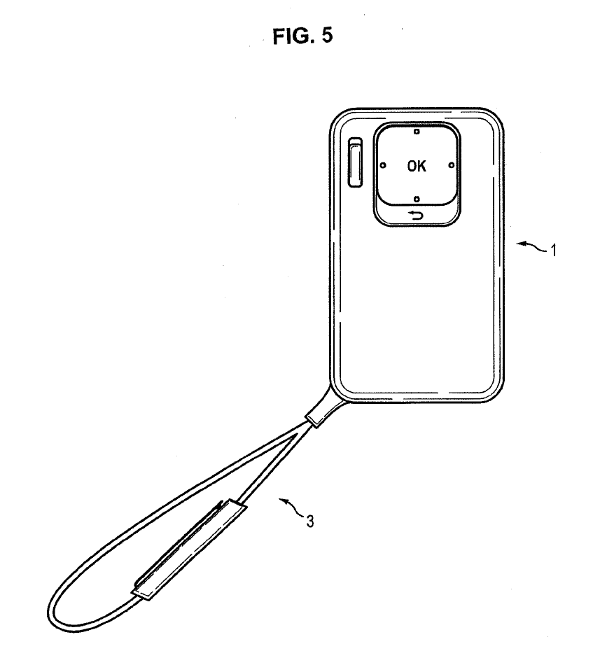

The device 1 may be used in a large plurality of applications. For example, but not as a limitation, the device 1 is selected from: a USB stick, a camera, a video camera, a computer, a projector or a portable telephone. Of course, the device 1 may fulfill several of the aforementioned functions. A non-limiting embodiment of the device is illustrated in FIG. 5.

As this is understood, the latter adapts immediately to any electronic device having a USB connector.

In particular, the proposed device allows optimum handling of the connections made by the connectors of the device, whether these are connections for data transfer or for energy transfer.

In particular, it is possible to handle in a fine way the charging of the battery of the device, depending on the different connection conditions of the connectors of the device.

The device also provides particular ergonomics, by the loop which the cable portions may make between them.

1. A device (1) including:
a cable portion (3) with a male USB connector (3a) connected to a module (2) being able to operate as a USB peripheral,
said device being characterized in that it also includes a cable portion with a female USB connector (3b) connected to the module, said module being able to also operate as a USB host, the male and female connectors being able to be connected with each other so that the cable portions form, together with the module, a loop, the module being configured for controlling data exchanges depending on the connection state of its male USB connector and of its female USB connector.

2. The device according to claim 1, comprising a battery (5), and wherein the module is configured for controlling the charging of its battery (5) depending on the connection state of its male USB connector and on its female USB connector.

3. The device (1) according to claim 2, wherein the module is configured for preventing the charging of the battery (5) when the connection state of the connectors corresponds to a connection between the male USB connector and the female USB connector.

4. The device (1) according to claim 2, wherein the module is configured for, when the male USB connector is connected to a source of energy, handling the intensity of the charging of its battery by the source of energy depending on the nature of the source.

5. The device (1) according to claim 4, wherein the module is configured for:
when the male USB connector is connected to an energy charging adaptor recommended by the manufacturer, imposing a charging intensity at a low level if the device is in an active condition, or a high level charging intensity if the device is in an inactive condition.

6. The device (1) according to claim 5, wherein the module is configured for:
when the male USB connector is connected to another charging adaptor or to other electronics, preventing the charging of the battery (5) of the device by the source if the device is in an inactive condition, and imposing a low level charging intensity if the device is in an active condition.

7. The device according to one of claims 1 to 6, wherein the module is configured for:
when the female USB connector is connected to an electronic device able to store data and not comprising any power supply, handling the absence of charging of its battery.

8. The device according to one of claims 1 to 7, wherein the module is configured for preventing any data transfer through the male and female USB connectors in the case of connection of the male USB connector with the female USB connector.

9. The device according to one of claims 1 to 8, wherein the cable portion (3) with a male USB connector (3a), and/or the cable portion (3) with a female USB connector (3b) further comprise:
an additional connector (9) for exchanging data, and/or
a memory card reader (10).

10. The device according to claim 9, wherein the additional connector (9) is an HDMI connector and/or the memory card reader (10) is an SD card reader.

11. The device according to one of claims 1 to 10, said device being selected from among: a USB stick, a camera, a video camera, a computer, a projector or a mobile telephone.
